(19) United States
(12) Patent Application Publication
(10) Pub. No.: US 2011/0198407 A1
(43) Pub. Date: Aug. 18, 2011

(54) METHOD AND APPARATUS TO BREAK UP OR ANNIHILATE TYPHOONS, TORNADOES, CYCLONES OR HURRICANES

(76) Inventors: Gheorghe T. Pop, Iasi (RO); Ioan Carcea, Iasi (RO); Octavian Ciobanu, Iasi (RO); Monica Rostami, Iasi (RO)

(21) Appl. No.: 12/706,274

(22) Filed: Feb. 16, 2010

(51) Int. Cl. A01G 15/00

(52) U.S. Cl. 239/2.1; 239/14.1

(57) ABSTRACT

This invention is about an efficient, but simple method and apparatus designed to break-up/annihilate disastrous natural phenomena, like typhoons, tornadoes, cyclones or hurricanes in the forming and deployment stages, on ground or on sea, by using a controlled implosion principle, which absorbs forced and fast air and water as displaced by typhoons, tornadoes, cyclones or hurricanes; the method and apparatus can be employed on sea, on ground or in the air.

### BACKGROUND OF THE INVENTION

There are several known proposals for destroying or protecting against disastrous natural phenomena, like typhoons, tornadoes, cyclones and hurricanes, which have been tried in the past. A general classification of the methods for destroying and protecting used so far can be found in US20020088364 and in US20040149156:
Structures that oppose the destructive action of typhoons, tornadoes, cyclones or hurricanes, including homes, commercial and social buildings;
Methods and equipments to break up/annihilate typhoons, tornadoes, cyclones or hurricanes that use a variety of energy sources like solar energy, explosive energy, etc.;
Chemical methods which use catalysis or below freezing temperatures to break-up/annihilate typhoons, tornadoes, cyclones or hurricanes nucleus.

Except for the first one, these methods appear to be practically non-implementable. In addition, they do not solve the problem of efficiently breaking-up/annihilating typhoons, tornadoes, cyclones or hurricanes, because they lack the necessary force and the efficient methods for coping with the physical-chemical parameters of these natural disasters.

### SUMMARY OF THE INVENTION

This invention is about an efficient, but simple method and apparatus designed to break-up/annihilate disastrous natural phenomena, like typhoons, tornadoes, cyclones or hurricanes (hereafter called “phenomena”) in the forming and deployment stages on sea or on ground.

According to the invention, the method and apparatus for breaking-up/annihilating phenomena overcomes most of the mentioned inconveniences. They can prevent or hinder the generation and development of phenomena in the forming phases, both at sea and on ground, in those areas which are frequently visited by such natural disasters. The utilized novel principle is controlled implosion, which is defined as a fast forced absorption of the air and/or water that are displaced by the phenomena.

### DETAILED DESCRIPTION OF THE INVENTION

The method and apparatus can have several constructive and functional embodiments: method and floating apparatus on sea, method and fixed apparatus on ground and method and apparatus launched from the air. All embodiments are capable of fast capturing in few minutes, by using controlled implosion (i.e. fast forced absorption), an immense quantity of air and water displaced by the phenomena during the generation phase, thus preventing the generation, development and deployment, as well as the disastrous consequences of the phenomena.

The break-up/annihilation apparatus is built basically by using a large number of vacuumed metallic recipients, assembled in batteries that might be fixed on a floating platform, on ground, as well as launched from airplanes.

A recipient battery is defined as an assembly of one or more recipients that can be vacuumed. Each battery has an intake valve that can be opened and closed in a controlled way, as well as an exhaust tube that serves for emptying the absorbed contents.

In one sea embodiment, several such floating platforms (generally between 6 and 9) can be tied elastically together, at predetermined distance, in order to form a platform assembly for a sea-based break-up/annihilation method and apparatus. The apparatus can be moved to the center of the forming phenomena by an appropriate number of draggers. Once in place, the platform assembly might be remotely controlled.

The nine floating platforms (350*250 m²/1150×820 sqft) might take up a huge sea area of nearly 100 ha (1 million m²/250 acres). They feature an absorbing and holding capacity of approx. 18 millions m³ (650 million cuft) of air-water mixture, a volume which matches that of a medium cyclone in generation/development stage. A floating platform can have a harboring capability of approximately 2,000 (32*21*3) recipients, each having an absorption volume of approx. 1000 m³ (35,000 cuft) of air-water mixture.

The vacuumed volume (approximately 18 million m³/650 million cuft) of the break-up/annihilation apparatus can be filled up with the air-water mixture in about 5-10 min, by controlled implosion, i.e. by fast forced absorption. This occurs by transforming the potential energy of the deeply vacuumed recipients into a huge kinetic energy, which is used for aspiration.

The absorbed mass can be calculated as follows:

Q=18.000.000/(10*60)=30.000 m³/s (1 million cuft/s),

Whereas the medium speed is:

w=150 m/s (500 ft/s)

The calculation formula for moving fluids is:

Q[m³/s]=S*w.

Thus resulting:

S=Q/w=30.000/150≈200 m² (2,200 sqft)

According to data from a US patent application publication US20020088364, the average energy of such disastrous phenomena is approx. 100-150 Giga Joules and the diameter of the center can measure up to several miles.

The potential energy of the vacuum in the metal recipients is transformed into a huge kinetic absorption force, as described by the formula:

F[J/s]=m*a=m*w/t, whereas:

m=is the mass of the air-water mixture absorbed from the phenomena; it is equivalent to the volume of the vacuumed recipients (18 million m³/650 million cuft) multiplied by the density of the mixture (0.5 Kg/dm³/0.015 lb/cuin) i.e. 18,000,000×0.5 kg (18 million lb);

w=the average forced absorption speed, which is approximately 150 m/s (500 ft/s);

t=the considered absorption time, herein approx. 5 min.

The above relations yield an absorption force of:

F=18.000.000*0.5*150/300=4.5*10⁶ J/s,

Calculations show that this kinetic energy is capable of absorbing from the center of the disastrous phenomena huge masses of air and water in several minutes, thus preventing the further evolution of the phenomena.

In one embodiment, the metal recipients, with a prismatic hexagonal shapes, can be assembled in three layers on a platform and grouped in batteries of 12 pieces each. Each battery is connected to a vertically fixed absorption tube that protrudes into the phenomena mass. In order to avoid an uncontrolled implosion, the recipient batteries (vacuumed at approx. 50 torr or 1 lb/sqin) are preprogrammed to open sequentially, while moving the apparatus towards the center of the phenomena.

The recipient battery forms the modular element of the apparatus and is used as reference for calculating the hydrodynamic parameters and the absorption force.

In one embodiment of the present invention these parameters are:
Debit of absorbed fluids from phenomena 12.000/300=40 m³/s (32,000 cuft/s);
Number of metallic recipients per battery 12
Total vacuum-able volume of a battery 12.000 m³ (380,000 cuft)
Estimated fill-up time for a battery: 5 min;
Average absorption speed: 150 m/s (500 ft/s)
Cross section of an absorption tube: 0.28 m² for \acute{Ø}=600 mm (2.8 sqft for \acute{Ø}=25 in)

The ground embodiment of the apparatus preserves the above mentioned constructive and functional principles. The only implementation difference to the sea embodiment is in the placing of the vacuumed metallic recipient batteries on reinforced concrete platforms.

The air launched embodiments use recipients or recipient batteries that are not assembled on fixed platforms, but launched individually, either freely, or by means of parachutes, from planes in the center of the phenomena.

### DESCRIPTION OF THE FIGURES

Here after are descriptions of the above mentioned constructive embodiments. They make reference to following figures:

FIG. 1. General view and functioning of the apparatus to break-up/annihilate phenomena—sea embodiment;

FIG. 2. General view and functioning of the apparatus to break-up/annihilate phenomena—ground embodiment;

FIG. 3. General view and functioning of the apparatus to break-up/annihilate phenomena—launched in the air, parachuted from airplane embodiments;

FIG. 4. Blueprint of a metallic recipient (general and inner view);

FIG. 5. Blueprint of the modular assembly of metallic recipients stacked in batteries;

FIG. 6. Blueprint for positioning recipient batteries for sea or ground platform embodiments.

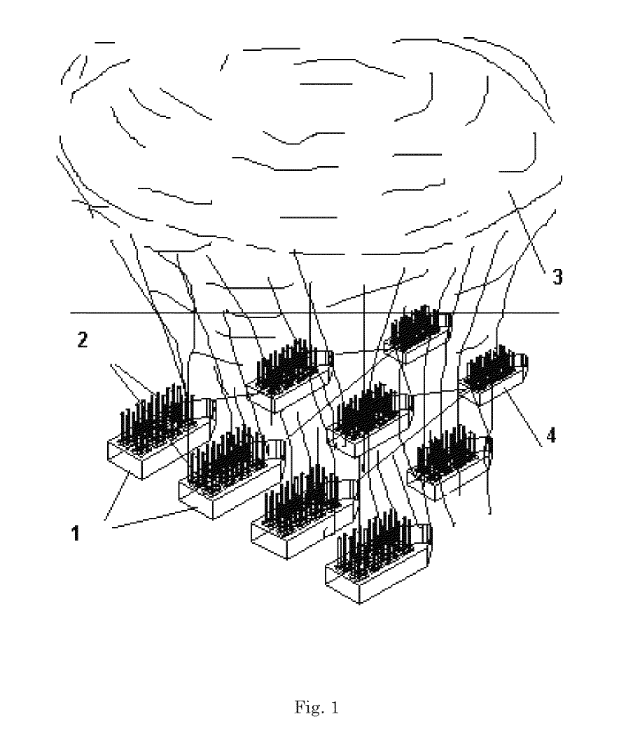

FIG. 1 depicts the sea floating embodiment of the apparatus to break-up/annihilate phenomena, built out of 9 sea floating platforms and carrying some 18 thousand vacuumed metallic recipients (2000 on each platform). For security reasons, only the metallic tubes 2 reach outside the platforms 1. The tubes are intended to absorb the phenomena air and water.

As soon as weather stations break the news about a new phenomena, i.e. in the initial developing phases, the apparatus (carrying the vacuumed recipients and the control module), will be towed towards the phenomena area by means of an appropriate number of draggers 4. They can be selected from the platforms, if equipped with adequate traction power. This phase can be crew controlled. Just before entering the phenomena area, the apparatus will be switched to the remote control mode, the crew will quit the platform, and the apparatus will be guided towards the center of the phenomena from an observation and control point placed on sea or on ground outside the impact area of the phenomena. While the apparatus enters the phenomena center, the intake valves of the recipient batteries are opened sequentially, contingent upon the phenomena speed and apparatus position. The vacuum generated in a controlled mode by the thousands of absorption tubes develops a huge absorption kinetic energy of approx. 10⁵-10⁷ Joule/s. This energy absorbs most of the phenomena mass 3 in the metallic recipients, thus breaking-up/annihilating the phenomena.

The intake valves can be controlled also wirelessly from a remote area through relays. The switching times can be made programmable. These times can be determined based on trials done in aerodynamic tunnels and fine trimmed based on real life measurements.

After the phenomena have been neutralized by losing their energy, the recipient batteries can be closed by the program in order to prevent the absorbed air-water mixture from exiting. The apparatus can be shored and prepared for future use by emptying the water from the recipients. The maintenance of the apparatus entails inspecting the absorption tubes, the exposed elements, and the intake valves functionality, as well as verifying the electric actuator and the control modules. Part of the maintenance is also the re-vacuuming of the recipient batteries. This can last for several weeks, depending on the capacity of the vacuuming mechanism.

In another embodiment, the vacuuming mechanism is based on the ejection principle. It can be implemented by means of large capacity ejectors, using the steam produced by a heat plant. The vacuuming mechanism can be placed on ground, close to the harbor where the apparatus is stationed. The vacuuming is performed while the recipient battery is shored between two phenomena, by using connection pipes.

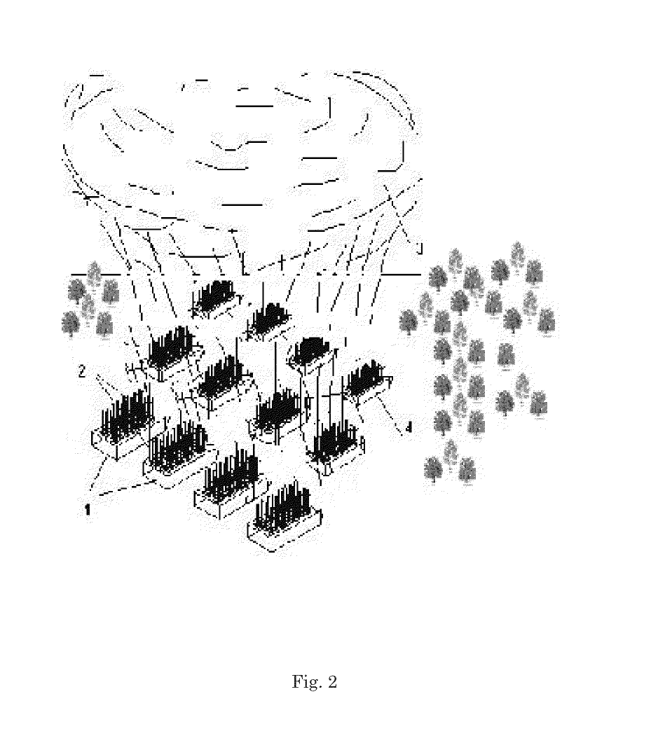

FIG. 2 depicts the ground embodiment of the method and apparatus for breaking-up/annihilating the phenomena. The apparatus can be placed on ground in areas that are frequently visited by such phenomena, as for example in the city of New Orleans, La., USA.

In this embodiment, the batteries will be placed on ground, on reinforced concrete foundations 1, built beneath the ground level. Therefore, the positioning of the batteries is simpler and the number of deployed batteries as well as the area of disposal can be significantly increased. A vacuuming mechanism can be placed in close vicinity. Recipient batteries can be placed contingent upon the dimensions, both width and length, as well as the geometry of the phenomena 3. In comparison to the sea embodiment, the ground embodiment allows the deployment of the apparatus over a larger area, creating the premise of being more efficient. An optimal placement of the apparatus is contingent upon the direction and physical dimensions of the phenomena. Similarly to the sea embodiment, the absorption tubes for the ground embodiment are the only parts that are directly exposed to the phenomena.

The dimension and hydrodynamic parameters of the phenomena, as well as the most frequently affected areas are studied and should be known by the specialized weather services. This apparatus embodiment allows for controlling the recipient batteries also from a fortified controlling point.

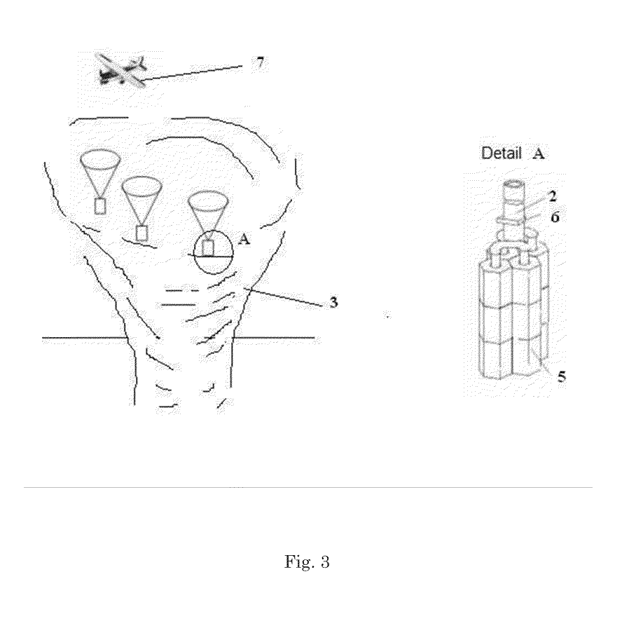

FIG. 3 depicts the air embodiment of the method and apparatus for breaking-up/annihilating of phenomena. In this case individual recipients or recipient batteries 5 are launched from airplanes 7. The batteries are launched in the center of the phenomena 3 freely or with parachutes, from a predetermined height (approximately 3-4 thousand meters/10-14 thousand feet) above the phenomena, during the generation phase over the sea.

The opening-closing time sequences for each intake valve, for recipient batteries that are launched from airplanes, are contingent upon the speed and duration the recipient batteries 5 travel within the phenomena. In one embodiment, each recipient battery can work individually. The number of batteries, their capacity, as well as the launching frequency is contingent upon the capacity and force of the phenomena. Calculations reveal that, in order to break-up/annihilate by fast forced absorption a medium sized phenomena, some 1,000 recipient batteries need to be dropped within 10-12 minutes. The actuation of the cylindrical device with opening-closing slots can be done mechanically, by means of a clock-like control mechanism.

The advantage of this embodiment is the fact that the vacuumed recipient batteries 5 are directly exposed to the phenomena, by protruding the phenomena center, where the mass is at its highest density. This creates the premise for a higher break-up/annihilation efficiency. The deployment of this apparatus embodiment highly depends on the availability of the necessary technical equipment needed to launch the optimal number of vacuumed recipients in a predetermined period of time. The number of metallic recipients, as well as their volume, needs to be correlated to the phenomena size and to the deployment capacity. After the operation is finished, the metallic recipient batteries can be recovered. These batteries will float if the program will close the absorption tubes of the recipients upon completion of the absorption cycle. Alternatively, the absorption tubes can be closed when the internal pressure of the recipient equals the outer pressure of the environment.

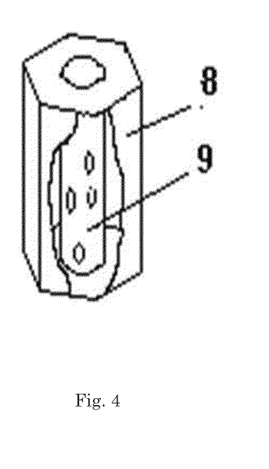

FIG. 4 depicts a metallic recipient battery of a hexagonal prismatic shape, which can have a volume of approximately 1.000 m³ (35,000 cuft) of vacuum-able space. The welded iron sheet construction and the hexagonal geometry of recipients 8 were chosen in order to ensure a maximum vacuum-able volume for a given surface, especially on floating sea platforms, as well as to reduce the metal consumption for the welded recipients (each hexagonal recipient has a common wall with the neighboring one). Also, the pilling in three or more layers optimizes space usage and ensures a ruggedized battery structure. The assembly of the metal recipient batteries can also be done in a hive like hexagonal structure.

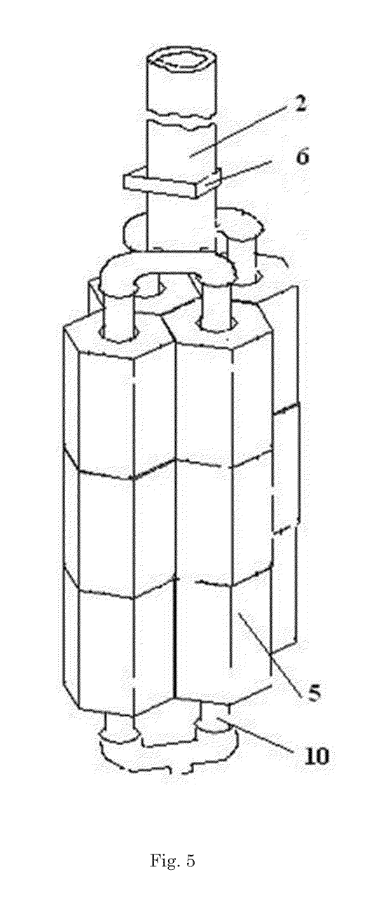

FIG. 5 depicts the blueprint of a battery with 12 metallic recipients connected by a common absorption tube 2 and an emptying tube 10.

Each recipient battery features an absorption tube with an opening-closing drawer, or an opening-closing cylinder with slots 6, as well as a water emptying tube 10 at the other end. The movable parts can be actuated electrically by means of a remote controlled motor. The absorption tube 2 of the battery is a cylinder that can have a variable height, from 10 to 30 m (30 to 90 ft). This absorption tube also supports the tubes connected to the vacuum pump. The water emptying tubes are interconnected.

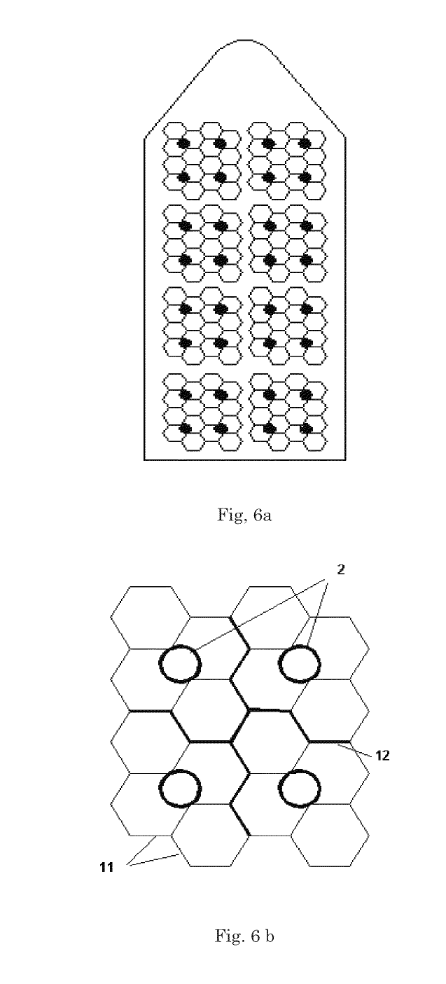

FIG. 6a depicts metal recipient batteries mounted individually on a platform in an assembly. They are fixed with screws to the floor and ceiling, so that they might be disassembled for repair. The number of batteries can reach several hundreds, depending on the platform capacity, on the type of boats used for transportation, as well as on the characteristics of the ground. The ground embodiment allows for mounting batteries over a larger area and for stacking recipients in more layers (more than the usual three).

The recipient batteries of a platform are interconnected by common absorption tubes which allow for evacuating the water, as well as for vacuuming the recipients. The recipients are also connected to electrical cables that supply the necessary energy and signals for controlling the opening-closing of the intake valves and drawers. The tubes that connect the batteries, the intake valves, the drawers, as well as other interconnecting elements are placed and fixed within metallic platforms in order to be protected from the heavy parts that might be brought along by the phenomena.

FIG. 6b details a separating space 12 between two adjacent batteries, which results from assembling the batteries onto the platform.

### SUMMARY OF BENEFITS

The present invention presents a series of advantages:
The apparatus to break-up/annihilate phenomena is a large metallic construction, relatively simple and very robust. It has no sensitive mobile elements which could be destroyed easily by the force of the phenomena; for better protection, the recipient body and the connecting elements are mounted under the upper metal floor of the platform;
The apparatus to break-up/annihilate phenomena can be implemented in three different constructive embodiments and placements, with different degrees of efficiency;
   The aerial embodiment of the apparatus allows for acting expeditiously during the generation phase of phenomena.
   The sea embodiment of the apparatus can be implemented on discharged boats by equipping them with metallic recipients, as proposed;
   The ground embodiment can be immobilized in those areas which are frequently visited by phenomena
The apparatus to break-up/annihilate phenomena can be readied long before deploying; it can be also placed on sea, in the vicinity where phenomena are frequent;
The effectiveness of the apparatus can be verified in theory on modular experimental platforms, as well as in practice, by implementing different versions according to the proposed concepts;
The apparatus to break-up/annihilate phenomena should be used in the initial developing phases of the phenomena; both the sea and the aerial embodiments can easily annihilate by controlled implosion (i.e. fast forced absorption) the phenomena, while still in the generation phase, before they reach ground;
The sea deployment of the apparatus to break-up/annihilate phenomena is uncomplicated; it can be towed by discharged boats of the navy if suitably adapted;
The apparatus to break-up/annihilate phenomena can be actuated and controlled remotely from a control point placed on a boat near the phenomena area, from an airplane or from the ground.

I claim:

1. A method to break up/annihilate a typhoon, tornado, cyclone or hurricane, the method comprising:
vacuuming a special built metal recipient which features an absorption tube and intake valves.

2. The method of claim 1, further comprising:
attaching the absorption tube of the recipient battery to a large capacity ejector that uses for vacuuming the steam produced by a steam plant.

3. The method of claim 2, further comprising:
closing the intake valves and detaching the large capacity ejector upon achieving the desired level of vacuum.

4. The method of claim 1, further comprising:
assembling a recipient battery, by bundling one or more vacuum-able recipients.

5. The method of claim 4, further comprising:
immobilizing the recipient battery within a metal platform.

6. The method of claim 5, further comprising:
immobilizing the metal platform onto the ground

7. The method of claim 6, further comprising:
opening the intake valves of the recipient battery for a predetermined period of time to create an implosion effect for the environment,
remote controlling the opening of the intake valves of the recipient battery, and
absorbing an amount of air-water into the vacuumed recipient battery by fast forced aspiration.

8. The method of claim 7, further comprising:
closing the intake valves of the recipient battery after the opening time expires, and
remote controlling the closing of the intake valves of the recipient battery.

9. The method of claim 7, further comprising:
closing the intake valves of the recipient battery after the internal pressure of the recipient battery equals the outer pressure of the environment, and
remote controlling the closing of the intake valves of the recipient battery.

10. The method of claim 5, further comprising:
immobilizing the metal platform onto a device that can float on water.

11. The method of claim 10, further comprising:
maneuvering the floating device so that the absorption tubes of the recipient battery protrude the moving air-water mass of a fast moving natural phenomenon.

12. The method of claim 11, further comprising:
opening the intake valves of the recipient battery for a predetermined period of time to create an implosion effect for the environment,
remote controlling the opening of the intake valves of the recipient battery, and
absorbing an amount of air-water into the vacuumed recipient battery by fast forced aspiration.

13. The method of claim 12, further comprising:
closing the intake valves of the recipient battery after the opening time expires, and
remote controlling the closing of the intake valves of the recipient battery.

14. The method of claim 12, further comprising:
closing the intake valves of the recipient battery when the internal pressure of the recipient battery equals the outer pressure of the environment, and
remote controlling the closing of the intake valves of the recipient battery.

15. The method of claim 4, further comprising:
freely dropping the recipient battery from an airplane into the moving air-water mass of a typhoon, tornado, cyclone or hurricane.

16. The method of claim 15, further comprising:
opening the intake valves for a predetermined period of time to create an implosion effect for the environment,
remote controlling the opening of the intake valves, and
absorbing an amount of air-water into the vacuumed recipient battery by fast forced aspiration.

17. The method of claim 16, further comprising:
closing the intake valves after the opening time expires, and
remote controlling the closing of the intake valves.

18. The method of claim 16, further comprising:
closing the intake valves after the internal pressure of the recipient battery equals the outer pressure of the environment, and
remote controlling the closing of the intake valves.

19. The method of claim 16, further comprising:
closing the intake valves when the recipient battery hits the water surface, and
remote controlling the closing of the intake valves.

20. The method of claim 17, further comprising:
Collecting the floating recipient batteries from the sea water

21. The method of claim 18, further comprising:
collecting the floating recipient batteries from the sea water.

22. The method of claim 19, further comprising:
collecting the floating recipient batteries from the sea water.

23. The method of claim 4, further comprising:
attaching the recipient battery to a parachute and parachuting the recipient battery from an airplane into the moving air-water mass of a typhoon, tornado, cyclone or hurricane.

24. The method of claim 23, further comprising:
opening the intake valves for a predetermined period of time to create an implosion effect for the environment,
remote controlling the opening of the intake valves, and
absorbing an amount of air-water into the vacuumed recipient battery by fast forced aspiration.

25. The method of claim 24, further comprising:
closing the intake valves after the opening time expires, and
remote controlling the closing of the intake valves.

26. The method of claim 24, further comprising:
closing the intake valves after the internal pressure of the battery equals the outer pressure of the environment, and
remote controlling the closing of the intake valves.

27. The method of claim 24, further comprising:
closing the intake valves when the recipient battery hits the water surface, and
remote controlling the closing of the intake valves.

28. The method of claim 25, further comprising:
collecting the floating recipient batteries from the sea water.

29. The method of claim 26, further comprising:
collecting the floating recipient batteries from the sea water.

30. The method of claim 27, further comprising:
collecting the floating recipient batteries from the sea water.

31. An apparatus to break up/annihilate a typhoon, tornado, cyclone or hurricane, the method comprising:
means for vacuuming a special built metal recipient which features an absorption tube and intake valves.

32. The apparatus of claim 31, further comprises:
means for attaching the absorption tube of the recipient battery to a large capacity ejector that uses for vacuuming the steam produced by a steam plant.

33. The apparatus of claim 32, further comprises:
means for closing the intake valves and detaching the large capacity ejector upon achieving the desired level of vacuum.

34. The apparatus of claim 31, further comprising
means for assembling a recipient battery, by bundling one or more vacuum-able recipients.

35. The apparatus of claim 34, further comprising:
means for immobilizing the recipient battery within a metal platform.

36. The apparatus of claim 35, further comprising:
means for immobilizing the metal platform onto the ground.

37. The apparatus of claim 36, further comprising:
means for opening the intake valves of the recipient battery for a predetermined period of time to create an implosion effect for the environment,
means for remote controlling the opening of the intake valves of the recipient battery, and
means for absorbing an amount of air-water into the vacuumed recipient battery by fast forced aspiration.

38. The apparatus of claim 37, further comprising:
means for closing the intake valves of the recipient battery after the opening time expires, and
means for remote controlling the closing of the intake valves of the recipient battery.

39. The apparatus of claim 37, further comprising:
means for closing the intake valves of the recipient battery after the internal pressure of the recipient battery equals the outer pressure of the environment, and
means for remote controlling the closing of the intake valves of the recipient battery.

40. The apparatus of claim 35, further comprising:
means for immobilizing the metal platform onto a device that can float on water.

41. The apparatus of claim 40, further comprising:
means for maneuvering the floating device so that the absorption tubes of the recipient battery protrude the moving air-water mass of a fast moving natural phenomenon.

42. The apparatus of claim 41, further comprising:
means for opening the intake valves of the recipient battery for a predetermined period of time to create an implosion effect for the environment,
means for remote controlling the opening of the intake valves of the recipient battery, and
means for absorbing an amount of air-water into the vacuumed recipient battery by fast forced aspiration.

43. The apparatus of claim 42, further comprising:
means for closing the intake valves of the recipient battery after the opening time expires, and
means for remote controlling the closing of the intake valves of the recipient battery.

44. The apparatus of claim 42, further comprising:
means for closing the intake valves of the recipient battery when the internal pressure of the recipient battery equals the outer pressure of the environment, and
means for remote controlling the closing of the intake valves of the recipient battery.

45. The apparatus of claim 34, further comprising:
means for freely dropping the recipient battery from an airplane into the moving air-water mass of a typhoon, tornado, cyclone or hurricane.

46. The apparatus of claim 45, further comprising:
means for opening the intake valves for a predetermined period of time to create an implosion effect for the environment.
means for remote controlling the opening of the intake valves, and
means for absorbing an amount of air-water into the vacuumed recipient battery by fast forced aspiration.

47. The apparatus of claim 46, further comprising:
means for closing the intake valves after the opening time expires, and
means for remote controlling the closing of the intake valves.

48. The apparatus of claim 46, further comprising:
means for closing the intake valves after the internal pressure of the recipient battery equals the outer pressure of the environment, and
means for remote controlling the closing of the intake valves.

49. The apparatus of claim 46, further comprising:
means for closing the intake valves when the recipient battery hits the water surface, and
means for remote controlling the closing of the intake valves.

50. The apparatus of claim 47, further comprising:
means for collecting the floating recipient batteries from the sea water.

51. The apparatus of claim 48, further comprising:
means for collecting the floating recipient batteries from the sea water.

52. The apparatus of claim 49, further comprising:
means for collecting the floating recipient batteries from the sea water.

53. The apparatus of claim 34, further comprising:
means for attaching the recipient battery to a parachute and parachuting the recipient battery from an airplane into the moving air-water mass of a typhoon, tornado, cyclone or hurricane.

54. The apparatus of claim 53, further comprising:
means for opening the intake valves for a predetermined period of time to create an implosion effect for the environment,
means for remote controlling the opening of the intake valves, and
means for absorbing an amount of air-water into the vacuumed recipient battery by fast forced aspiration.

55. The apparatus of claim 54, further comprising:
means for closing the intake valves after the opening time expires,
means for remote controlling the closing of the intake valves.

56. The apparatus of claim 54, further comprising:
means for closing the intake valves after the internal pressure of the battery equals the outer pressure of the environment, and
means for remote controlling the closing of the intake valves.

57. The apparatus of claim 54, further comprising:
means for closing the intake valves when the recipient battery hits the water surface, and
means for remote controlling the closing of the intake valves.

58. The apparatus of claim 55, further comprising:
means for collecting the floating recipient batteries from the sea water.

59. The apparatus of claim 56, further comprising:
means for collecting the floating recipient batteries from the sea water.

60. The apparatus of claim 57, further comprising:
means for collecting the floating recipient batteries from the sea water.
